(19) United States
(12) Patent Application Publication
(10) Pub. No.: US 2012/0023511 A1
(43) Pub. Date: Jan. 26, 2012

(54) Slot-In Disc Drive Having Adjustable Disc Ejection Distance

(75) Inventors: Ta-Hsiang WANG, Hsinchu (TW); Chien-Wei HUANG, Hsinchu (TW); Yung-Han WU, Hsinchu (TW); Sheng-Hsiung CHOU, Hsinchu (TW)

(73) Assignee: LITE-ON IT CORP., Hsinchu (TW)

(21) Appl. No.: 13/251,398

(22) Filed: Oct. 3, 2011

Related U.S. Application Data
(62) Division of application No. 12/726,561, filed on Mar. 18, 2010.

(30) Foreign Application Priority Data
Mar. 26, 2009 (CN) 200910129681.0

(51) Int. Cl. G11B 17/051

(52) U.S. Cl. 720/623; G9B/17.033

(57) ABSTRACT

A slot-in disc drive is provided to comprise an ejecting lever rotated about a rotating axis; a first sensor and a second sensor, disposed on the rotating path of the ejecting lever; and a firmware, built in the disc drive for selecting a first setting or a second setting according to the size of a loaded disc, wherein the first and the second settings are respectively related to the first and the second sensors, and the firmware controls the ejecting lever to stop rotating based on the selected setting.

The present application is a divisional application of U.S. patent application Ser. No. 12/726,561 filed on Mar. 18, 2010, which claims the benefit from the priority of China Application Serial Number 200910129681.0, filed on Mar. 26, 2009, the disclosures of which are incorporated by reference herein in their entirety.

### BACKGROUND OF THE INVENTION

1. Field of the Invention

The present invention relates to a slot-in disc drive, particularly to a slot-in disc drive, which has a disc ejection module to adjust the disc ejecting distance.

2. Description of the Prior Art

With the technology of electronic and mechanical industries continue to develop and progress, the quality of computer peripherals such as hard drives, disc drives, scanners, printers and so on are becoming better. As far as the storage medium of the disc drive is concerned, the standard disc has evolved from the 700 MB storage capacity of traditional CD (compact disc) or VCD's to the latest 4.7 GB storage capacity of the DVD, a digital versatile disc. As these types of discs are capable of storing data in very long term, they have become the mainstream of the market for storing data. Whereas, no matter the capacity varies, a popular and standard size of the disc is still classified into two sizes of 12 cm and 8 cm in diameter.

The disc drive for reading the discs can be classified into a tray-loading disc drive and a slot-in disc drive. The tray-loading disc drive comprises a tray for supporting a disc and loading/ejecting the disc into/out of the disc drive. In comparing with the tray-loading disc drive, an ejecting module is built in the slot-in disc drive for loading/ejecting the disc from a slot formed on front side of the slot-in disc drive.

However, a problem is found in the slot-in disc drive while a small-size disc such as an 8 cm disc is loaded or unloaded. The ejecting module of the slot-in disc drive is usually by means of an ejecting lever, however, the final position of the ejecting lever is usually fixed no matter the disc size is an 8 cm disc or a 12 cm disc. Thus, the 8 cm disc may be not ejected fully.

Please refer to FIG. 1 and FIG. 2. FIG. 1 and FIG. 2 show, respectively, an ejecting lever 3 at an ejecting position with a 12 cm disc and an 8 cm disc of a conventional slot-in disc drive 10. Usually, the ejecting lever 3 is used in the slot-in disc drive 10 for ejecting the disc. The ejecting lever 3 is a thin rod with one end pivoted on and rotated about an axis 31, and a roller 32 is mounted on the other end of the ejecting lever 3. When loading the disc, the rim of the disc contacts the roller 32 and pushes the ejecting lever 3 to rotate inward into the slot-in disc drive; when ejecting the disc, the ejecting lever 3 is driven to rotate toward a front slot of the slot-in disc drive, therefore, pushes the disc out of the slot-in disc drive.

In conventional slot- in disc drive, the final ejecting position of the ejecting lever 3 is fixed no matter what size the disc has. Hence, as shown in FIG. 1 and FIG. 2, after completing the disc ejection, the ejecting distance d2 measured from the front door for the 8 cm disc 5 is much shorter than the ejecting distance d1 for the 12 cm disc 4. Under above final ejecting position of the ejecting lever 3, it can be seen that the central hole of the 12 cm disc 4 is located outside the slot-in disc drive, so it is convenient for an user to take the 12 cm disc 4. Unfortunately, it is difficult for the user to take out the 8 cm disc 5 under the same final ejecting position as the ejecting distance d2 is too short.

Furthermore, if the final ejecting position of the ejecting lever is designed to be suitable for an 8 cm disc, the ejecting distance d1 of a 12 cm disc may too long, therefore, causing the 12 cm disc dropped out from the slot-in disc drive.

Accordingly, an object of the present invention is to overcome foregoing problems.

### SUMMARY OF THE INVENTION

A slot-in disc drive is provided to comprise an ejecting lever rotated about a rotating axis; a first sensor and a second sensor, disposed on the rotating path of the ejecting lever; and a firmware, built in the disc drive for selecting a first setting or a second setting according to the size of a loaded disc, wherein the first and the second settings are respectively related to the first and the second sensors, and the firmware controls the ejecting lever to stop rotating based on the selected setting.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows an ejecting lever at an ejecting position with a 12 cm disc of a conventional slot-in disc drive.

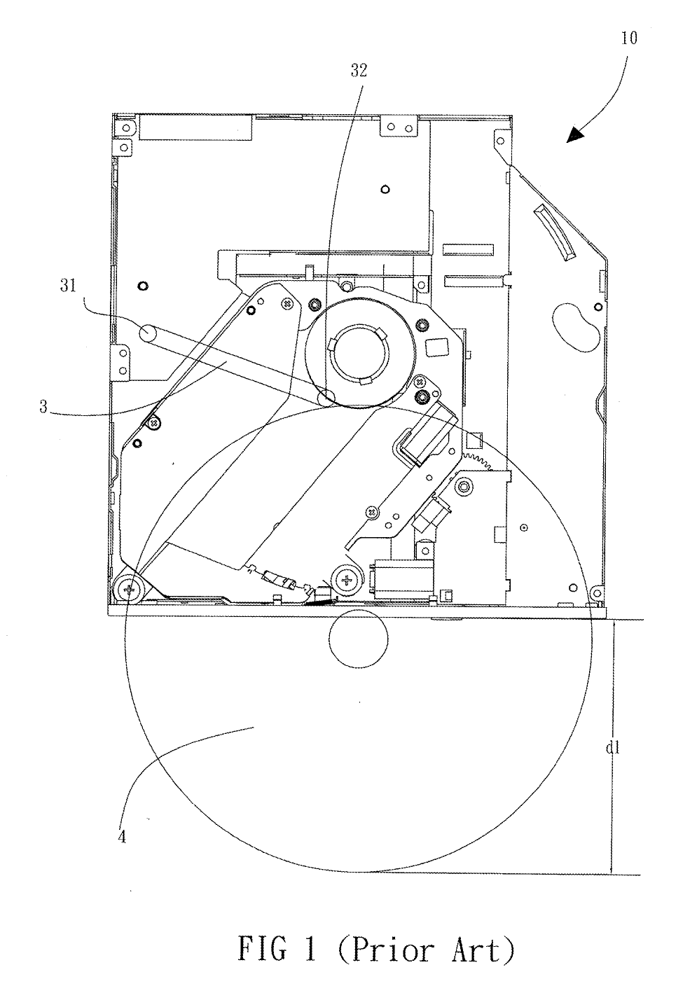

FIG. 2 shows the ejecting lever at the ejecting position with an 8 cm disc of the conventional slot-in disc drive.

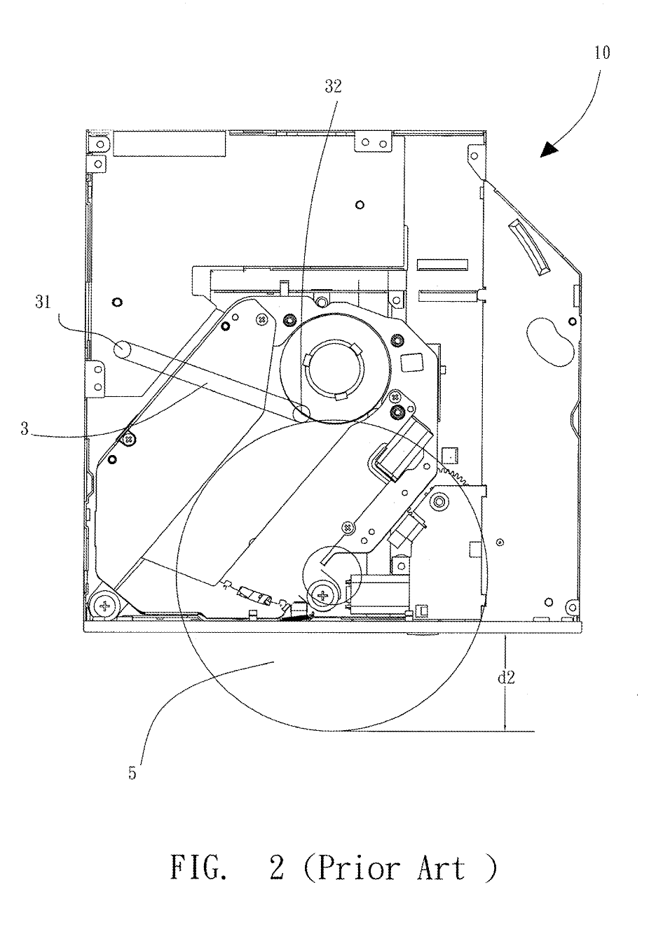

FIG. 3 shows a 12 cm disc in a slot-in disc drive before being ejected according to a first preferred embodiment of the present invention.

FIG. 4 shows the 12 cm disc in the slot-in disc drive after being ejected according to the first preferred embodiment of the present invention.

FIG. 5 shows an 8 cm disc in the slot-in disc drive after being ejected according to the first preferred embodiment of the present invention.

FIG. 6 shows a 12 cm disc in a slot-in disc drive after being ejected according to a second preferred embodiment of the present invention.

FIG. 7 shows an 8 cm disc in a slot-in disc drive after being ejected according to the second preferred embodiment of the present invention.

### DETAILED DESCRIPTION OF THE INVENTION

A slot-in disc drive according to the present invention includes sensor or limit switch and/or an end point and a firmware to control the ejecting position of the ejecting lever so that the big size (12 cm) disc or small (8 cm) disc will be ejected and stopped at a predetermined ejecting distances.

When a disc is loading into a slot-in disc drive, as the rotating inertia momentum of the disc will vary with the size of the disc, the rotating inertia momentum of the disc is used as a factor to judge the size of the disc. Usually, the larger disc with a larger rotating inertia momentum. The other way to judge the size of the disc is using the read head to detect the disc size directly. After confirming the disc size, a firmware built in the slot-in disc drive decides the ejecting position of the ejecting lever according to the disc size when ejecting the disc.

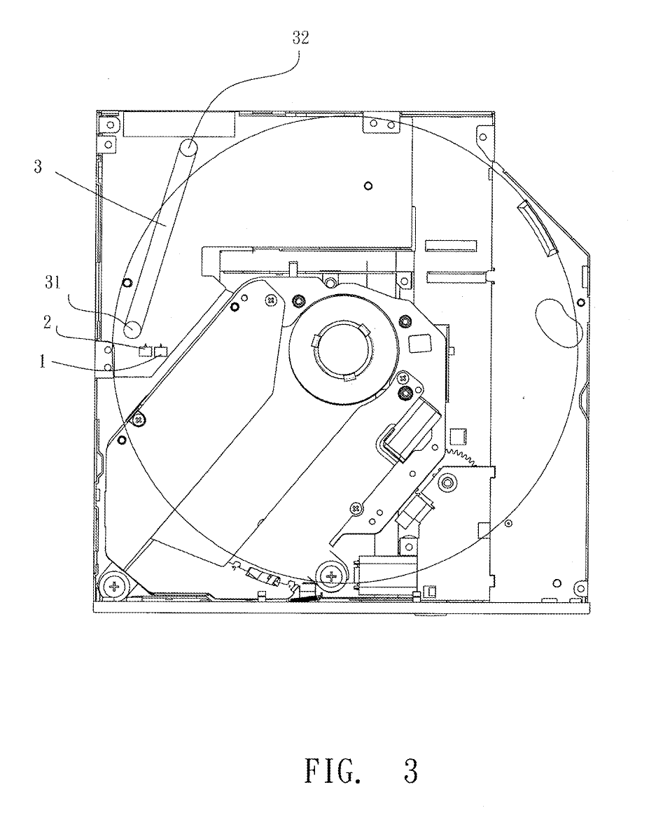

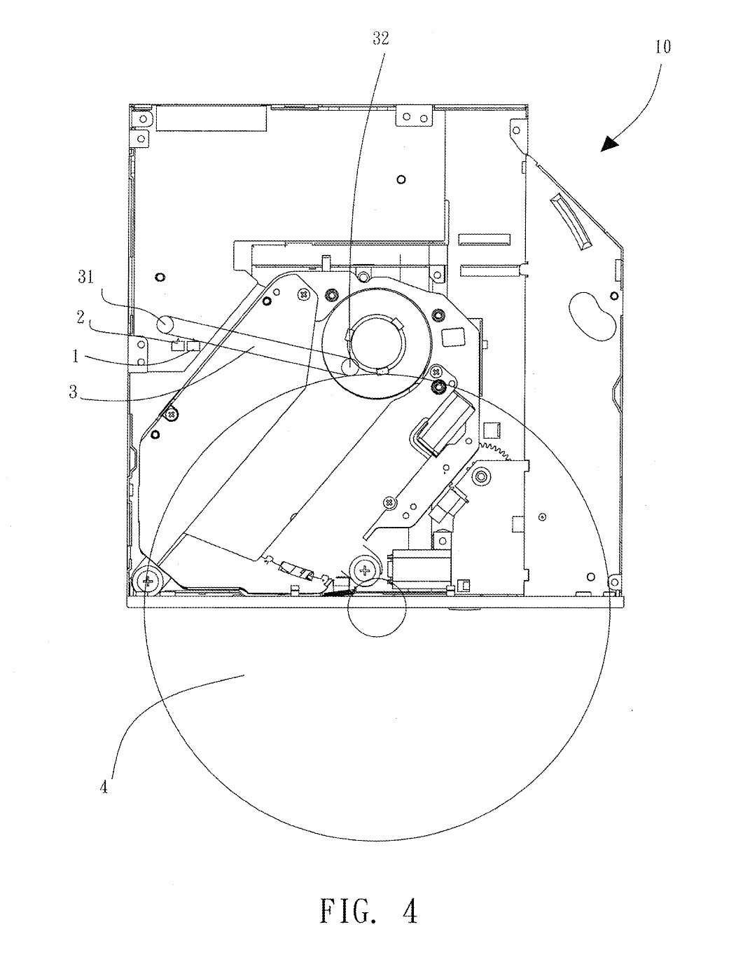

Referring to FIG. 3, it shows a 12 cm disc in a slot-in disc drive before being ejected according to a first preferred embodiment of the present invention. As forgoing description, after a disc 4 is loaded, the slot-in disc drive has judged the size of the disc 4 is a 12 cm disc. Subsequently, when a disc ejecting command is performed, the ejecting lever 3 is driven by a transmission unit (not shown) to rotate about the rotating axis 31 and leads the roller 32 to push the rim of the 12 cm disc 4 to eject the 12 cm disc 4. Referring to FIG. 4, it shows the 12 cm disc in the slot-in disc drive after being ejected according to the first preferred embodiment of the present invention. While the disc drive detects that the disc 4 is a 12 cm disc, the firmware built in the disc drive selects a first setting to control the ejecting lever 3 to stop rotating based on the first sensor 1. Therefore, when ejecting disc, the rotation of the ejecting lever 3 will not be stopped until the ejecting lever 3 touches the first sensor 1 according to the first setting. In the exemplary example, a signal is sent to the firmware once the ejecting lever 3 touches the first sensor 1 to stop the motion of the ejecting lever 3. At that time, the ejecting lever 3 is stopped at a position near the first sensor 1.

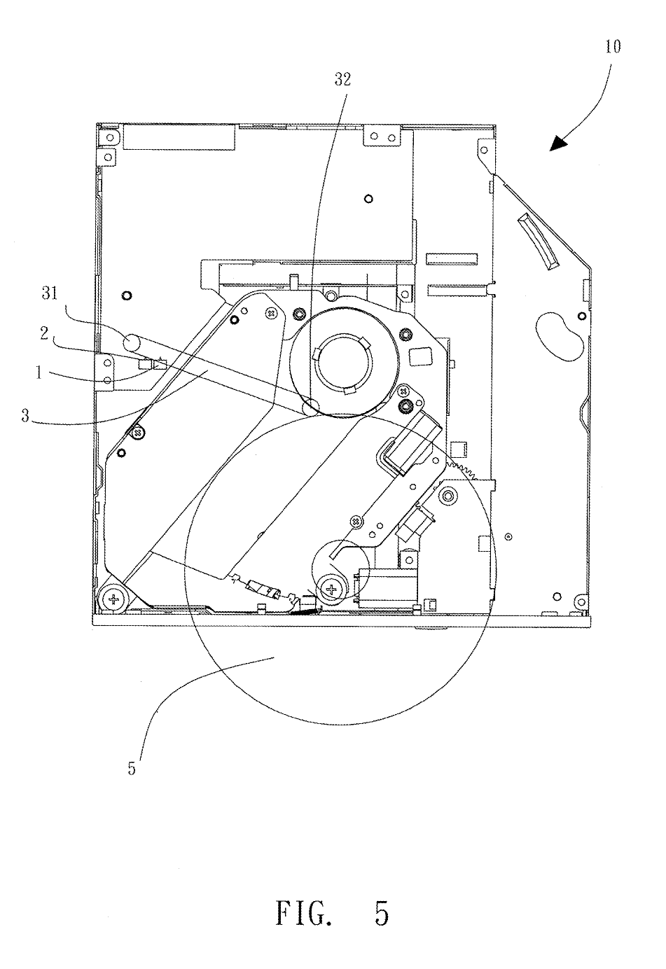

With respect to the ejection of the 8 cm disc, please refer to FIG. 5. FIG. 5 shows an 8 cm disc in the slot-in disc drive after being ejected according to the first preferred embodiment of the present invention. After loading a disc 5, the size of the disc 5 is judged. When the disc 5 is judged as an 8 cm disc, the firmware built in the disc drive selects a second setting to control the ejecting lever 3 to stop rotating based on the second sensor 2. When a disc ejecting command is performed, the ejecting lever 3 is driven to rotate about the rotating axis 31 and leads the roller 32 to push the rim of the 8 cm disc 5 to eject the 8 cm disc 5. Besides, the rotation of the ejecting lever 3 will not be stopped until the ejecting lever 3 touches the second sensor 2. In the exemplary example, a signal is sent to the firmware once the ejecting lever 3 touches the second sensor 2 to stop the motion of the ejecting lever 3. At that time, the ejecting lever 3 is stopped at a position near the second sensor 2.

During the ejection of the 8 cm disc 5, the ejecting lever 3 first touches the first sensor 1, and the firmware also receives the signal from the first sensor. However, the second setting is selected by the firmware to control the ejecting lever 3 to stop rotating based on the second sensor 2 according to the judgment that the disc size is an 8 cm disc, the firmware will ignore the signal from the first sensor 1. Therefore, after touching the first sensor 1, the ejecting lever 3 will continue to push the 8 cm disc 5, till the ejecting lever 3 touches the second sensor 2.

Accordingly, with the first sensor 1, the second sensor 2 and the firmware provided in the present application, the ejecting lever 3 will selectively be stopped at different ejecting position and eject the disc with different suitable ejecting distance according to the size of the disc.

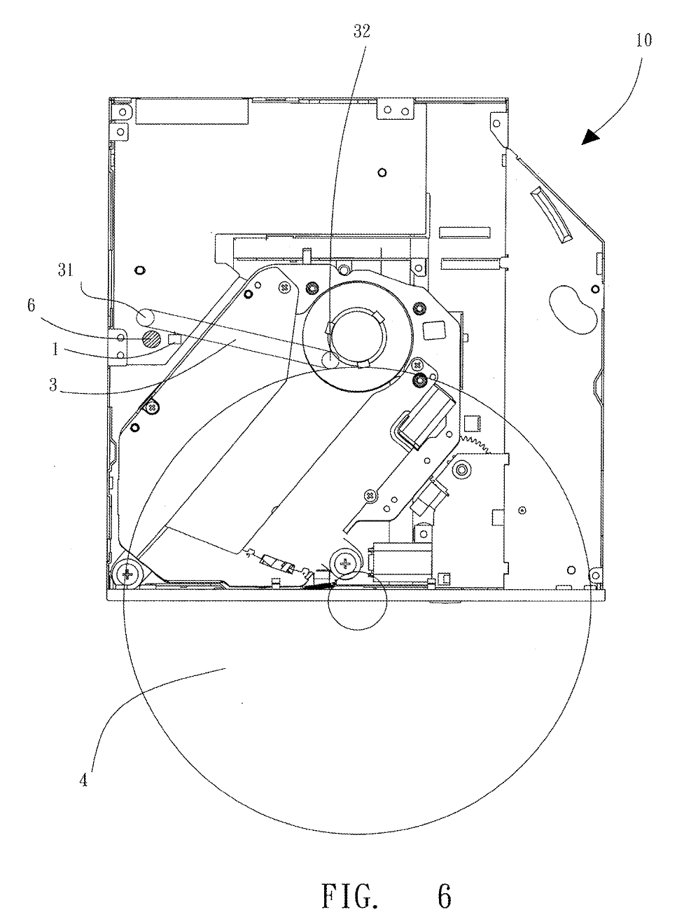

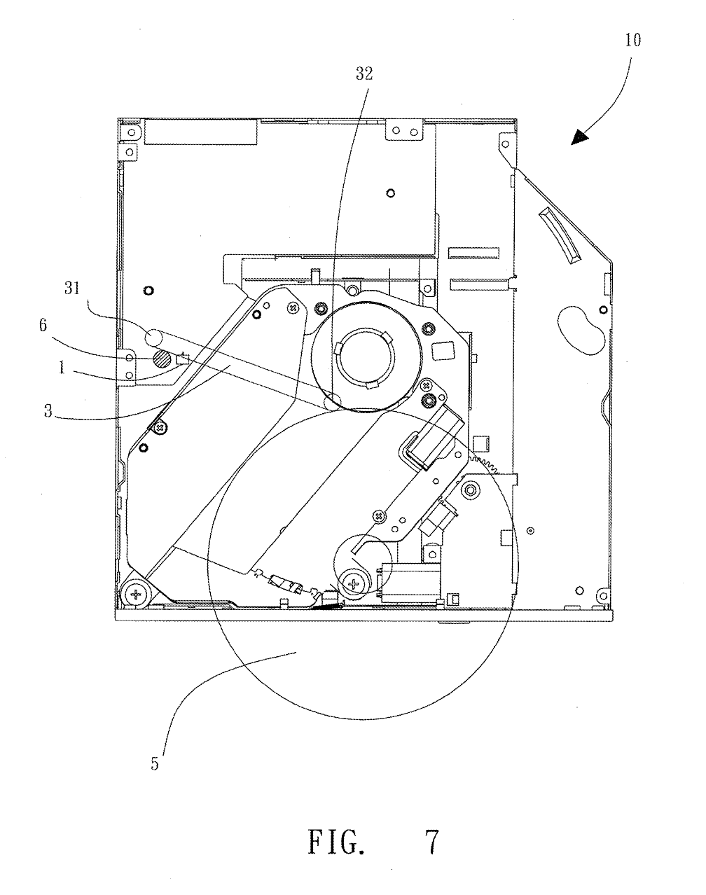

Alternatively, the second sensor can be replaced by an ending point 6. As shown in FIG. 6 and FIG. 7, FIG. 6 and FIG. 7 respectively show a 12 cm disc and an 8 cm disc in a slot-in disc drive after being ejected according to a second preferred embodiment of the present invention. According to the second preferred embodiment, as the loaded disc is judged to be a 12 cm disc, the firmware built in the disc drive will set a first setting to control the ejecting lever 3 to stop rotating based on the first sensor 1. Otherwise, as the loaded disc is judged to be an 8 cm disc, the firmware built in the disc drive will set a second setting to ignore the signal sent from the first sensor 1. According to the settings of different disc sizes, when ejecting the 8 cm disc, the rotating of the ejecting lever 3 is stopped when it reaches the end point 6. When ejecting the 12 cm disc, the rotating of the ejecting lever 3 is stopped when it touches the first sensor 1.

According to the present invention, the ejecting position of the ejecting lever can be changed by the settings of the firmware according to different ejecting conditions.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A slot-in disc drive comprises:
an ejecting lever rotated about a rotating axis, and the rotation motion of the ejecting lever has an ending point;
a first sensor, disposed on the rotating path of the ejecting lever; and
a firmware, built in the disc drive for selecting a first setting or a second setting according to the size of a loaded disc detected,
wherein, the first and the second settings are respectively related to the first sensor and the ending point, and the firmware controls the ejecting lever to stop rotating based on the selected setting.

2. The slot-in disc drive according to claim 1 wherein when the loaded disc is a 12 cm disc, the firmware controls the ejecting lever to stop rotating based on the first sensor.

3. The slot-in disc drive according to claim 1 wherein when the loaded disc is an 8 cm disc, the firmware ignores the first sensor and controls the ejecting lever to stop rotating while reaching the ending point.
